(19) United States
(12) Patent Application Publication
(10) Pub. No.: US 2006/0228932 A1
(43) Pub. Date: Oct. 12, 2006

(54) Electrical Connector, Wire Harness, and Method for Arranging Wire Harness

(76) Inventor: Ryuichi Komiyama, Tokyo (JP)

Correspondence Address: BARLEY SNYDER, LLC, 1000 WESTLAKES DRIVE, SUITE 275, BERWYN, PA, 19312, US

(21) Appl. No.: 11/279,081

(22) Filed: Apr. 7, 2006

(30) Foreign Application Priority Data
Apr. 8, 2005 (JP) 2005-112601

(51) Int. Cl. H01R 13/58

(52) U.S. Cl. 439/467

(57) ABSTRACT

An electrical connector connected to a flat cable, a wire harness, and a method for arranging wire harness is disclosed. Arranging the wire harness is easy and simple, the cost is low, and the degree of freedom in the housing construction is high. The electrical connector 10 has a plurality of mutually stackable base housings 11a, 11b, and 11c having the same shape, with each of these base housings 11a, 11b, and 11c having contact receiving cavities 16a, 16b, and 16c in a single row. At least one lock housing 40 is attached to the uppermost and/or lowermost base housing of the plurality of stacked base housings 11a, 11b, and 11c. A plurality of contacts 30a, 30b, and 30c are connected to the flat cable 2 and are inserted in the contact receiving cavities 16a, 16b, and 16c.

### FIELD OF THE INVENTION

The present invention relates to an electrical connector and more particularly to an electrical connector for a flat cable, a wire harness, and a method for arranging the wire harness.

### BACKGROUND OF THE INVENTION

Wire harnesses in which electrical connectors are connected to flat cables, including flexible circuit boards (FPC), have been used in the past mainly in electronic devices such as personal computers. In recent years, however, there has been an increasing demand for the use of such wire harnesses for the connection to controllers in the automotive field or the like.

For example, wire harnesses in which electrical connectors are connected to flat cables are used for the connection to automotive transmission controllers. In such cases, installation involves pulling an electrical connector connected to the end portion of a flat cable out of an opening in the transmission case.

In such cases, when a multipole connector in which a plurality of contacts are arranged in multiple rows is used as an electrical connector, the size of the electrical connector is increased, so that the opening bored in the transmission case is also inevitably increased. In order to solve this problem, a method is conceivable in which a plurality of stackable connectors each having a plurality of contacts arranged in a single row are prepared, the plurality of connectors are connected to the end portion of a flat cable, the individual connectors are successively pulled out through a relatively small opening bored in the transmission case, and the individual connectors are subsequently stacked up and integrated.

The connector shown in FIGS. 12 and 13A to 13C (see JP10-74541A), for example, is a known stackable connector in which a plurality of contacts are arranged in a single row. FIG. 12 is a perspective view of the upper-stage, middle-stage, and lower-stage base housings and FIGS. 13A to 13C are explanatory diagrams of such a conventional connector assembly.

This connector 101 shown in FIG. 12 comprises upper-stage, middle-stage, and lower-stage base housings 110a, 110b, and 110c, and a plurality of contacts 120 (see FIGS. 13A to 13C) inserted in the respective base housings 110a, 110b, and 110c.

A plurality of contact receiving cavities 111 in a single row having the upper surfaces thereof open are formed in the upper-stage base housing 110a, and a cover body 115 that covers the upper surfaces of the contact receiving cavities 111 is integrally formed and joined by hinges 115a to the upper-stage base housing 110a. A pair of locking projections 116 are formed at either end of the cover body 115, and a pair of locking recesses 114 with which the locking projections 116 are locked are formed in either side wall of the base housing 110a.

Furthermore, a plurality of contact receiving cavities 111 in a single row having the upper surfaces thereof open are also formed in the middle-stage base housing 110b.

Moreover, a plurality of contact receiving cavities 111 in a single row having the upper surfaces thereof open are likewise formed in the lower-stage base housing 110c.

In addition, the upper-stage, middle-stage, and lower-stage base housings 110a, 110b, and 110c are arranged so that these base housings 110a, 110b, and 110c are linked in a staircase like pattern with the upper surfaces of the contact receiving cavities 111 in each of the base housings 110a, 110b, and 110c. The upper-stage and middle-stage base housings 110a and 110b are linked by a frangible thin part 117a, the middle-stage and lower-stage base housings 110b and 110c are linked by a frangible thin part 117b, and these upper-stage, middle-stage, and lower-stage base housings 110a, 110b, and 110c are formed integrally from an insulative material. Furthermore, these base housings 110a, 110b, and 110c are constructed so that the middle-stage base housing 110b can be stacked on top of the lower-stage base housing 110c, and so that the upper-stage base housing 110a can be stacked on top of the middle-stage base housing 110b. A pair of locking projections 112 are formed on the bottom wall of the middle-stage base housing 110b, and a pair of locking recesses 113 are formed in either side wall of the lower-stage base housing 110c to engage the locking projections 112 when the middle-stage base housing 110b is stacked. Likewise, a pair of locking projections 112 are formed on the bottom wall of the upper-stage base housing 110a, and a pair of locking recesses 113 are formed in either side wall of the middle-stage base housing 110b to engage the locking projections 112 when the upper-stage base housing 110a is stacked.

As is shown in FIG. 13A, when assembling the connector 101, the contacts 120 are first inserted into the contact receiving cavities 111 of the respective base housings 110a, 110b, and 110c, and individual electrical wires W are connected by Insulation Displacement Connection (IDC) to the respective contacts 120 in this state.

Next, as is shown in FIG. 13B, the thin part 117a that links the upper-stage base housing 110a and middle-stage base housing 110b and the thin part 117b that links the middle-stage base housing 110b and lower-stage base housing 110c are cut.

Finally, as is shown in FIG. 13C, the middle-stage base housing 110b is stacked on top of the lower-stage base housing 110c, and the upper-stage base housing 110a is stacked on top of the middle-stage base housing 110b. Subsequently, the cover body 115 provided on the upper-stage base housing 110a is pivoted in the direction of arrow A shown in FIG. 12 to cover the upper surfaces of the respective contact receiving cavities 111. As a result, the connector 101 is completed.

With this connector 101, since a plurality of base housings 110a, 110b, and 110c are formed by a single molding process as one linked body, the number of parts can be reduced, and the work efficiency can be increased as a result of the simplification of the parts.

In the connector 101 shown in FIGS. 12 and 13A to 13C, individual electrical wires W are connected by IDC to the respective contacts 120, but it would also be possible to connect the end portion of a flat cable to the respective contacts 120. Furthermore, if the thin parts 117a and 117b are cut following the connection of the flat cable to the respective contacts, the individual base housings 110a, 110b, and 110c are pulled out of the opening in the transmission case, and the individual base housings 110a, 110b, and 110c are subsequently stacked up, then the opening in the transmission case or the like can be made smaller.

However, in the case of the connector 101 shown in FIGS. 12 and 13A to 13C, while arranging the wire harness, it is necessary to cut the thin parts 117a and 117b that are provided in order to form a plurality of base housings 110a, 110b, and 110c as one linked body in a single molding process. Therefore, there is a problem in that arranging the wire harness becomes troublesome.

Furthermore, in cases where the number of contacts 120 is increased or decreased in the connector 101, the number of base housings must be increased or decreased. However, since thin parts that link adjacent base housings are present, the degree of freedom in the housing construction is low, and a new mold for molding base housings is required in such cases, so that manufacturing is complicated, and there is a concern of increased cost.

### SUMMARY

Accordingly, the present invention was devised in light of the problems described above. It is an object of the present invention to provide an electrical connector connected to a flat cable, a wire harness, and a method for arranging a wire harness in which arranging the wire harness is simple and easy, the cost is low, and the degree of freedom in the housing construction is high.

An electrical connector according to am embodiment of the invention has a plurality of mutually stackable base housings having the same shape, with each of these base housings having contact receiving cavities in a single row. At least one lock housing is attached to the uppermost and/or lowermost one of the stacked base housings and a plurality of contacts that are connected to the flat cable are inserted into the contact receiving cavities in the plurality of base housings.

Furthermore, a method for arranging wire harness comprises the steps of: connecting a plurality of contacts to a flat cable; inserting the plurality of contacts in the contact receiving cavities in a single row in a plurality of base housings; passing each of the plurality of base housings successively through an opening in a housing; stacking the plurality of base housings; and attaching at least one lock housing to the uppermost and/or lowermost base housing of the plurality of stacked base housings.

### BRIEF DESCRIPTION OF THE DRAWINGS

The invention will now be described by way of example with reference to the following Figures of which:

FIG. 1 is a perspective view of the wire harness of the present invention as seen from above and from the front;

FIG. 2 is a perspective view of the wire harness shown in FIG. 1 as seen from above and from the back;

FIGS. 3A and 3B show the wire harness of FIG. 1, with FIG. 3A being a plan view, and FIG. 3B being a front view;

FIG. 4 is a sectional view along line 4-4 in FIG. 3A;

FIG. 5 is a sectional view along line 5-5 in FIG. 3B;

FIG. 6 is a schematic plan view of a flexible circuit board (FPC);

FIG. 7 is a perspective view illustrating a step of inserting a plurality of contacts connected to the FPC in the contact receiving cavities of upper-stage, middle-stage, and lower-stage base housings;

FIG. 8 is a perspective view illustrating a step of pivoting about hinge parts strain relief members respectively provided on the upper-stage, middle-stage, and lower-stage base housings;

FIG. 9 is a perspective view in a state in which the strain relief members are pivoted about the hinge parts;

FIG. 10 is a perspective view illustrating a step of attaching a lock housing to the upper-stage base housing that is located at the very top of the stacked upper-stage, middle-stage, and lower-stage base housings;

FIG. 11 is a perspective view illustrating a step of attaching a lock housing to the upper-stage base housing that is located at the very top of the stacked upper-stage, middle-stage, and lower-stage base housings;

FIG. 12 is a perspective view of the upper-stage, middle-stage, and lower-stage base housings constituting a conventional example of a connector; and

FIGS. 13A to 13C are explanatory diagrams of a conventional example of a connector assembly.

### DETAILED DESCRIPTION OF THE EMBODIMENTS

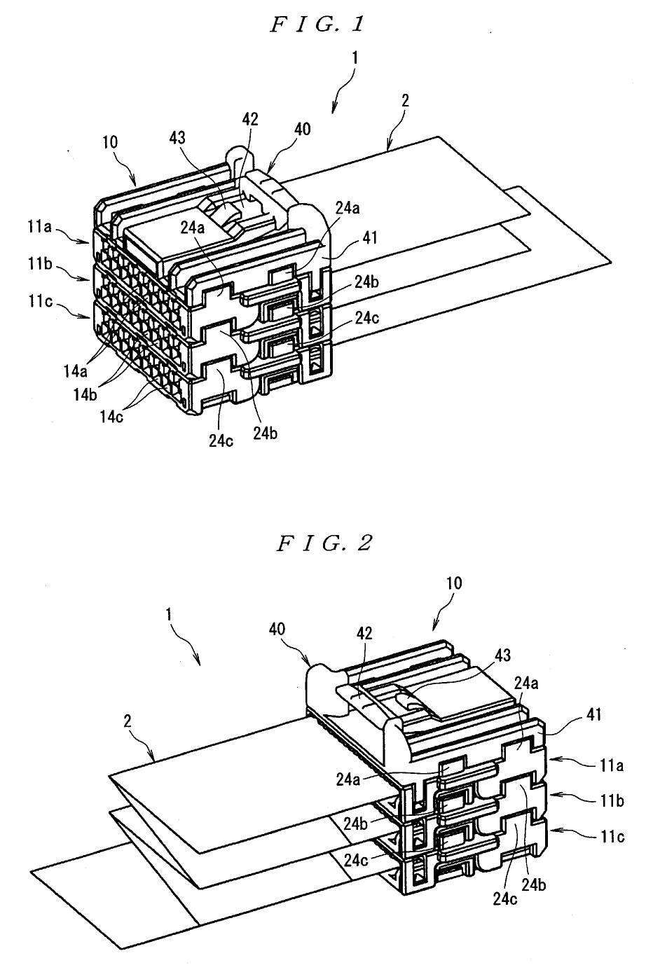

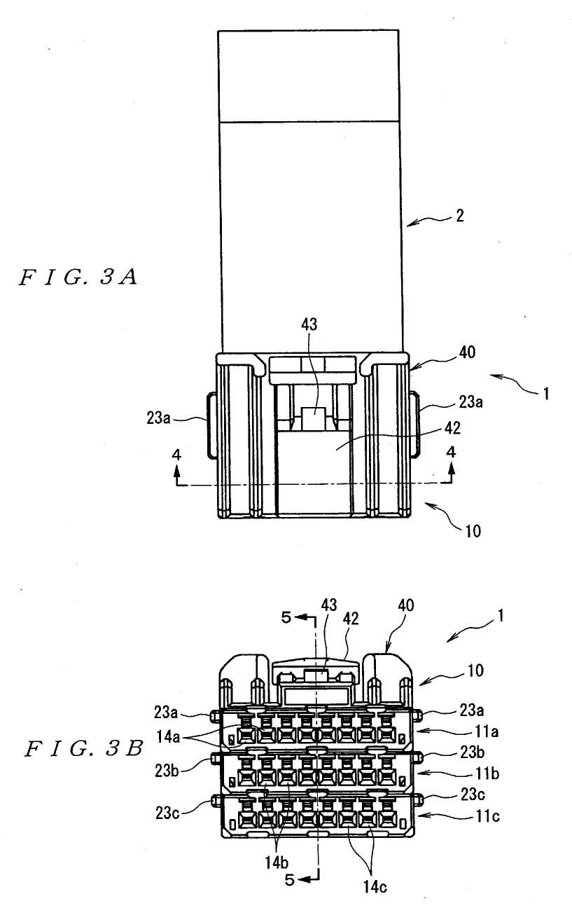

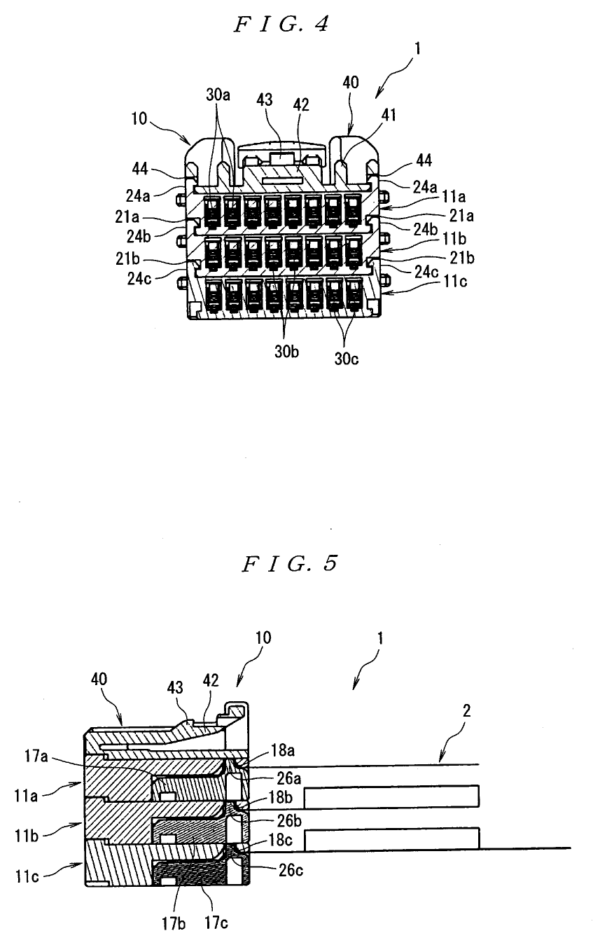

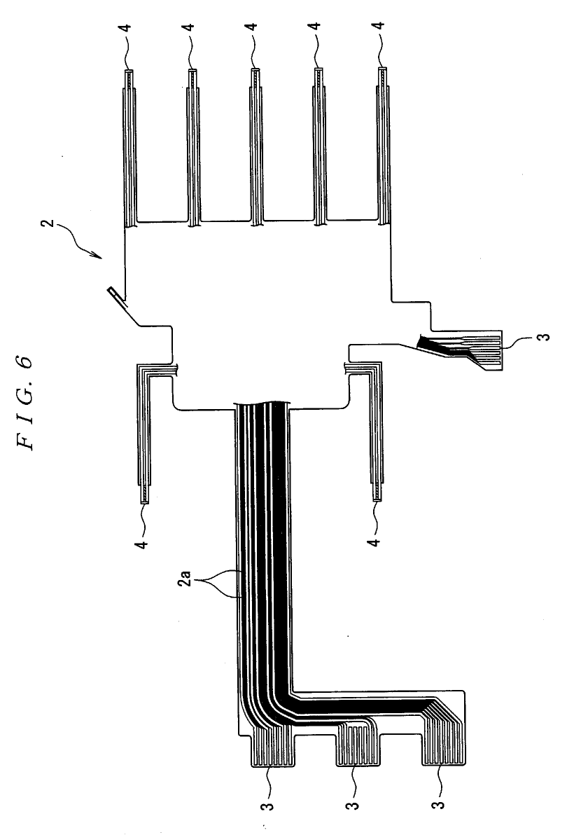

Next, an embodiment of the present invention will be described with reference to the figures. Referring to FIGS. 1 through 5, the wire harness 1 is formed by connecting an electrical connector 10 to one end of a flexible circuit board (FPC) 2. Here, as is shown in FIG. 6, for example, a FPC 2 is used which has a plurality of conductor patterns 2a on one surface thereof, and which comprises three first terminal sections 3 on one end, five second terminal sections 4 on the other end, and one first terminal section 3 and two second terminal sections 4 substantially in the central portion.

Here, the electrical connector 10 comprises mutually stackable upper-stage, middle-stage, and lower-stage base housings 11a, 11b, and 11c that have the same shape, and a lock housing 40. Although the electrical connector 10 is not limited to a connector comprising upper-stage, middle-stage, and lower-stage base housings 11a, 11b, and 11c, i.e., three stages of base housings, a case in which the connector comprises base housings in three stages will be described below.

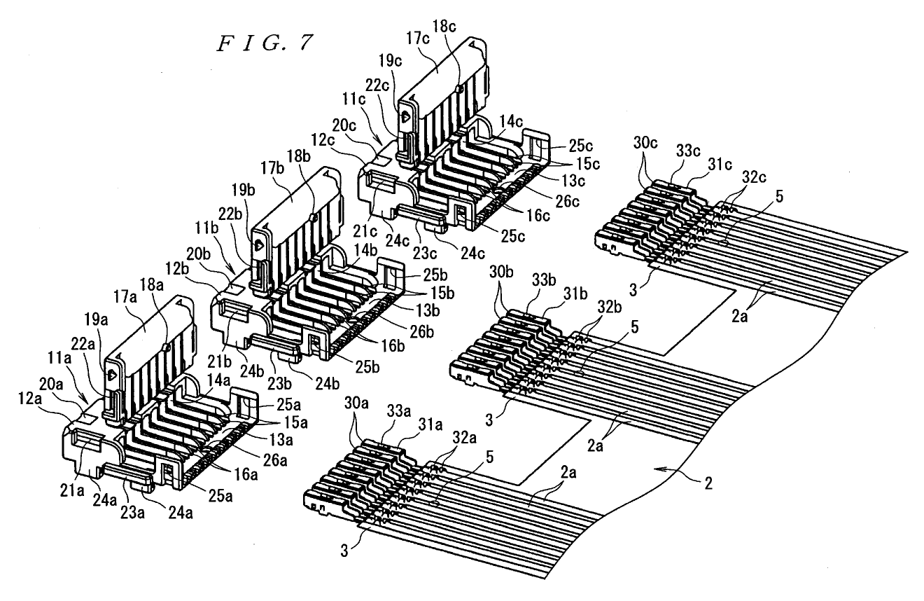

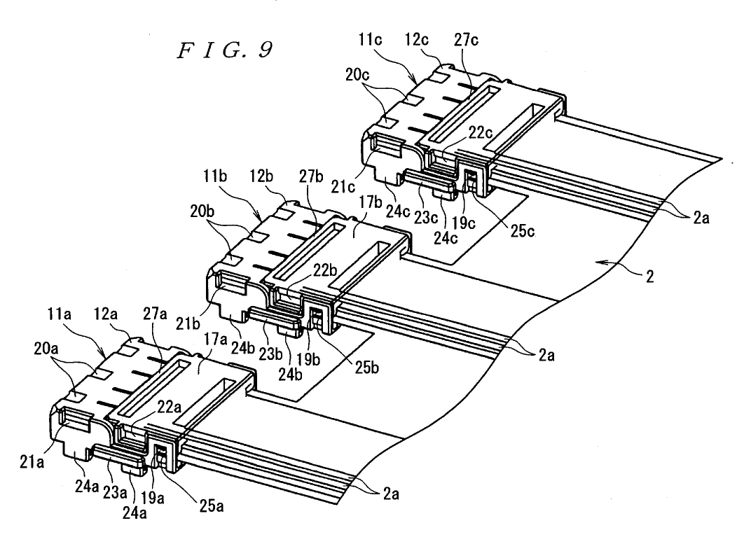

As is shown most clearly in FIG. 7, the upper-stage base housing 11a comprises a substantially rectangular housing main body 12a that has a plurality of contact receiving holes 14a in a single row, and a bottom plate part 13a that extends rearward (rightward in FIG. 7) from the housing main body 12a. The upper-stage base housing 11a is formed by molding an insulative material. A plurality of pairs of side walls 15a that extend rearward from the rear surface of the housing main body 12a in positions corresponding to both sides of the contact receiving holes 14a are formed on the bottom plate part 13a, and contact receiving cavities 16a are defined by the contact receiving holes 14a and the spaces between the pairs of side walls 15a. Thus, the plurality of contact receiving cavities 16a in a single row are formed in the upper-stage base housing 11a. Furthermore, a strain relief member 17a is integrally provided via a hinge part 27a (see FIG. 9) on the undersurface (upper surface in FIG. 7) of the housing main body 12a of the upper-stage base housing 11a. A strain relief projection 18a is formed so as to protrude substantially from the central portion in the direction of width of the strain relief member 17a, and a recess 26a into which the strain relief projection 18a is inserted is formed in the bottom plate part 13a. Moreover, a pair of locking projections 19a are provided on either side surface of the strain relief member 17a and a pair of locking parts having locking holes 25a with which the locking projections 19a are locked are provided in an upright attitude on the bottom plate part 13a. In addition, a plurality of protruding parts 28a (see FIG. 11) are provided on the upper surface of the housing main body 12a, and a pair of locking projections 24a that protrude upward are also provided on either side of the housing main body 12a. Furthermore, a pair of locking projections 24a that protrude upward are provided on either side of the bottom plate part 13a as well. These locking projections 24a respectively engage with locking recesses 44 formed in the lock housing 40, and the protruding parts 28a are fitted into grooves 45 formed in the lock housing 40, so that these parts have the function of preventing excessive looseness of the lock housing 40. Moreover, a plurality of grooves 20a are formed in the undersurface of the housing main body 12a, and a pair of locking recesses 21a are formed at either side of the housing main body 12a beneath the locking projections 24a. In addition, a pair of locking recesses 22a are also formed in either side of the strain relief member 17a.

Furthermore, the middle-stage base housing 11b has the same shape as the upper-stage base housing 11a, and comprises a substantially rectangular housing main body 12b that has a plurality of contact receiving holes 14b in a single row, and a bottom plate part 13b that extends rearward from the housing main body 12b as shown most clearly in FIG. 7. The middle-stage base housing 11b is formed by molding an insulative material. A plurality of pairs of side walls 15b that extend rearward from the rear surface of the housing main body 12b in positions corresponding to both sides of the contact receiving holes 14b are formed on the bottom plate part 13b, and contact receiving cavities 16b are demarcated by the contact receiving holes 14b and the spaces between the pairs of side walls 15b. Thus, the plurality of contact receiving cavities 16b in a single row are formed in the middle-stage base housing 11b. Furthermore, a strain relief member 17b is integrally provided via a hinge part 27b (see FIG. 9) on the undersurface (upper surface in FIG. 7) of the housing main body 12b of the middle-stage base housing 11b. A strain relief projection 18b is formed so as to protrude substantially from the central portion in the direction of width of this strain relief member 17b, and a hole 26b into which the strain relief projection 18b is inserted is formed in the bottom plate part 13b. Moreover, a pair of locking projections 19b are provided on either side surface of the strain relief member 17b in the direction of width, and a pair of locking parts having locking holes 25b with which the locking projections 19b are locked are installed in an upright attitude on the bottom plate part 13b. In addition, a plurality of protruding parts (not shown in the figures) are provided on the upper surface of the housing main body 12b, and a pair of locking projections 24b that protrude upward are also provided on either side of the housing main body 12b. Furthermore, a pair of locking projections 24b that protrude upward are provided on either side of the bottom plate part 13b as well. These locking projections 24b, 24b respectively engage with the locking recesses 21a, 22a formed in the upper-stage base housing 11a, and the protruding parts are fitted into the grooves 20a formed in the upper-stage base housing 11a. Moreover, a plurality of grooves 20b are formed in the undersurface of the housing main body 12b, and a pair of locking recesses 21b are formed at either side of the housing main body 12b beneath the locking projections 24b. In addition, a pair of locking recesses 22b are also formed in either side of the strain relief member 17b.

Furthermore, the lower-stage base housing 11c has the same shape as the upper-stage base housing 11a and middle-stage base housing 11b, and comprises a substantially rectangular housing main body 12c that has a plurality of contact receiving holes 14c in a single row, and a bottom plate part 13c that extends rearward from the housing main body 12c as shown most clearly in FIG. 7; the lower-stage base housing 11c is formed by molding an insulating resin. A plurality of pairs of side walls 15c that extend rearward from the rear surface of the housing main body 12c in positions corresponding to both sides of the contact receiving holes 14c are formed on the bottom plate part 13c, and contact receiving cavities 16c are demarcated by the contact receiving holes 14c and the spaces between the pairs of side walls 15c. Thus, the plurality of contact receiving cavities 16c in a single row are formed in the lower-stage base housing 11c. Furthermore, a strain relief member 17c is integrally provided via a hinge part 27c (see FIG. 9) on the undersurface (upper surface in FIG. 7) of the housing main body 12c of the lower-stage base housing 11c. A strain relief projection 18c is formed so as to protrude substantially from the central portion in the direction of width of this strain relief member 17c, and a hole part 26c into which the strain relief projection 18c is inserted is formed in the bottom plate part 13c. Moreover, a pair of locking projections 19c are provided on either side surface of the strain relief member 17c in the direction of width, and a pair of locking parts having locking holes 25c with which the locking projections 19c are locked are installed in an upright attitude on the bottom plate part 13c. In addition, a plurality of protruding parts (not shown in the figures) are provided on the upper surface of the housing main body 12c, and a pair of locking projections 24c that protrude upward are also provided on either side of the housing main body 12c. Furthermore, a pair of locking projections 24c that protrude upward are provided on either side of the bottom plate part 13c as well. These locking projections 24c, 24c respectively engage with the locking recesses 21b, 22b formed in the middle-stage base housing 11b, and the protruding parts are fitted into the grooves 20b formed in the middle-stage base housing 11b. Moreover, a plurality of grooves 20c are formed in the undersurface of the housing main body 12c, and a pair of locking recesses 21c are formed at either side of the housing main body 12c beneath the locking projections 24c. In addition, a pair of locking recesses 22c are also formed in either side of the strain relief member 17c. Thus, the lower-stage base housing 11c is constructed so that another base housing having the same shape as the upper-stage, middle-stage, and lower-stage base housings 11a, 11b, and 11c can also be stacked underneath this lower-stage base housing 11c. Furthermore, a pair of projections 23a, 23b, and 23c for preventing twisting during mating with a mating connector (not shown in the figures) are respectively provided on either end surface in the direction of width of the upper-stage, middle-stage, and lower-stage base housings 11a, 11b, and 11c.

Moreover, the lock housing 40 is to be attached to the surface of the upper-stage base housing 11a that is located in the uppermost position of the stacked upper-stage, middle-stage, and lower-stage base housings 11a, 11b, and 11c. The lock housing 40 comprises a substantially rectangular lock housing main body 41, a cantilever locking arm 42 that is provided substantially in the central portion of the lock housing main body 41 in the direction of width, and a locking projection 43 that is provided on the upper surface of the locking arm 42; the lock housing 40 is formed by molding an insulating resin. The locking projection 43 of the locking arm 42 engages with the locking part of a mating connector (not shown in the figures), thus having the function of preventing the electrical connector 10 from coming out of the mating connector. Furthermore, the locking recesses 44, 44 with which the locking projections 24a, 24a provided on the upper-stage base housing 11a respectively engage are formed in either side of the lock housing main body 41. In addition, a plurality of grooves 45 into which the protruding parts 28a provided on the upper-stage base housing 11a are fitted are formed in the undersurface of the lock housing main body 41.

Furthermore, as is shown in FIG. 7, a plurality of upper-stage contacts 30a are connected to the first terminal section 3 that is located on the rightmost side (left side in FIG. 7) of the three first terminal sections 3 provided on one end of the FPC 2, a plurality of middle-stage contacts 30b are connected to the first terminal section 3 located in the middle, and a plurality of lower-stage contacts 30c are connected to the first terminal section 3 located on the leftmost side. Among these connected contacts, the upper-stage contacts 30a are designed to be inserted into the contact receiving cavities 16a in the upper-stage base housing 11a, the middle-stage contacts 30b are designed to be inserted into the contact receiving cavities 16b in the middle-stage base housing 11b, and the lower-stage contacts 30c are designed to be inserted into the contact receiving cavities 16c in the lower-stage base housing 11c. The “electrical connector” stipulated in claim 1 is constructed form the upper-stage, middle-stage, and lower-stage base housings 11a, 11b, and 11c, lock housing 40, and upper-stage, middle-stage, and lower-stage contacts 30a, 30b, and 30c. Here, each of the upper-stage, middle-stage, and lower-stage contacts 30a, 30b, and 30c is formed by stamping and forming a metal plate, and comprises a substantially box-shaped receptacle part 31a, 31b, or 31c that receives a mating contact (not shown in the figures), a connecting part 32a, 32b, or 32c that extends from the receptacle part 31a, 31b, or 31c and that is connected to the corresponding first terminal section by piercing, and a locking part 33a, 33b, or 33c that is provided on the receptacle part 31a, 31b, or 31c and that is locked inside the contact receiving hole 14a, 14b, or 14c.

Next, a method for arranging wire harness will be described in reference to FIGS. 7 through 11.

For example, if a description is given in a case where the wire harness 1 is connected to a controller for an automotive transmission, first, as is shown in FIG. 7, the plurality of upper-stage contacts 30a are connected by piercing to the first terminal section 3 that is located on the rightmost side (left side in FIG. 7) of the three first terminal sections 3 provided on one end of the FPC 2, the plurality of middle-stage contacts 30b are connected by piercing to the first terminal section 3 located in the middle, and the plurality of lower-stage contacts 30c are connected by piercing to the first terminal section 3 located on the leftmost side.

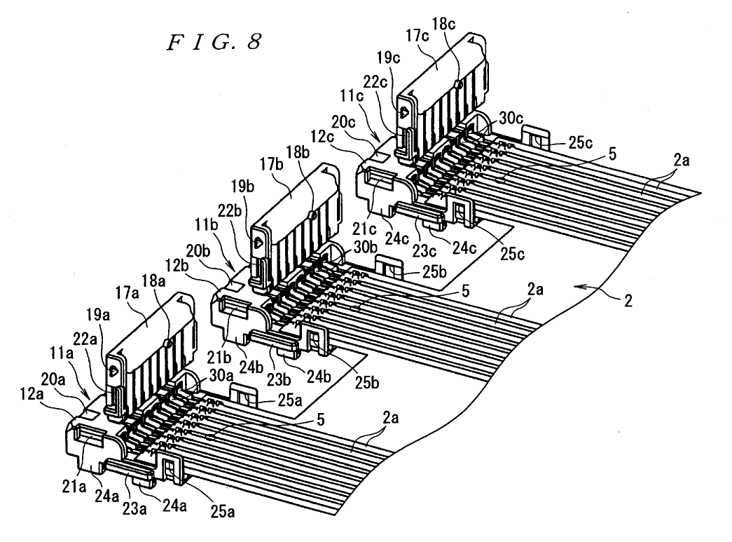

Next, the plurality of upper-stage contacts 30a connected to the FPC 2 are inserted into the contact receiving cavities 16a in a single row in the upper-stage base housing 11a, the plurality of middle-stage contacts 30b are inserted into the contact receiving cavities 16b in a single row in the middle-stage base housing 11b, and the plurality of lower-stage contacts 30c are inserted into the contact receiving cavities 16c in a single row in the lower-stage base housing 11c. As a result, the state shown in FIG. 8 is obtained.

Then, the strain relief member 17a provided on the upper-stage base housing 11a is caused to pivot about the hinge part 27a, so that the strain relief projection 18a is engaged with the hole part 26a via an opening 5 formed in the FPC 2. At this point, the locking projections 19a are locked with the locking holes 25a, so that the strain relief member 17a is locked. As a result, in cases where an external force is applied to the FPC 2, it is possible to relieve the stress generated in the first terminal section 3 of the FPC 2 to which the upper-stage contacts 30a are connected. Furthermore, the strain relief member 17b provided on the middle-stage base housing 11b is similarly caused to pivot about the hinge part 27b, so that the strain relief projection 18b is engaged with the hole 26b via an opening 5 formed in the FPC 2, and the locking projections 19b are locked with the locking holes 25b, thus locking the strain relief member 17b. As a result, in cases where an external force is applied to the FPC 2, it is possible to relieve the stress generated in the first terminal section 3 of the FPC 2 to which the middle-stage contacts 30b are connected. Moreover, the strain relief member 17c provided on the lower-stage base housing 11c is similarly caused to pivot about the hinge part 27c, so that the strain relief projection 18c is engaged with the hole part 26c via an opening 5 formed in the FPC 2, and the locking projections 19c are locked with the locking holes 25c, thus locking the strain relief member 17c. As a result, in cases where an external force is applied to the FPC 2, it is possible to relieve the stress generated in the first terminal section 3 of the FPC 2 to which the lower-stage contacts 30c are connected. Consequently, in cases where vibration occurs, the stress generated in the first terminal sections 3 of the FPC 2 can be relieved by the strain relief members 17a, 17b, and 17c, which makes it possible to produce an electrical connector that is suitable for use as an automotive connector. As a result, the state shown in FIG. 9 is obtained.

Next, the respective upper-stage, middle-stage, and lower-stage base housings 11a, 11b, and 11c are successively passed through an opening in the transmission case.

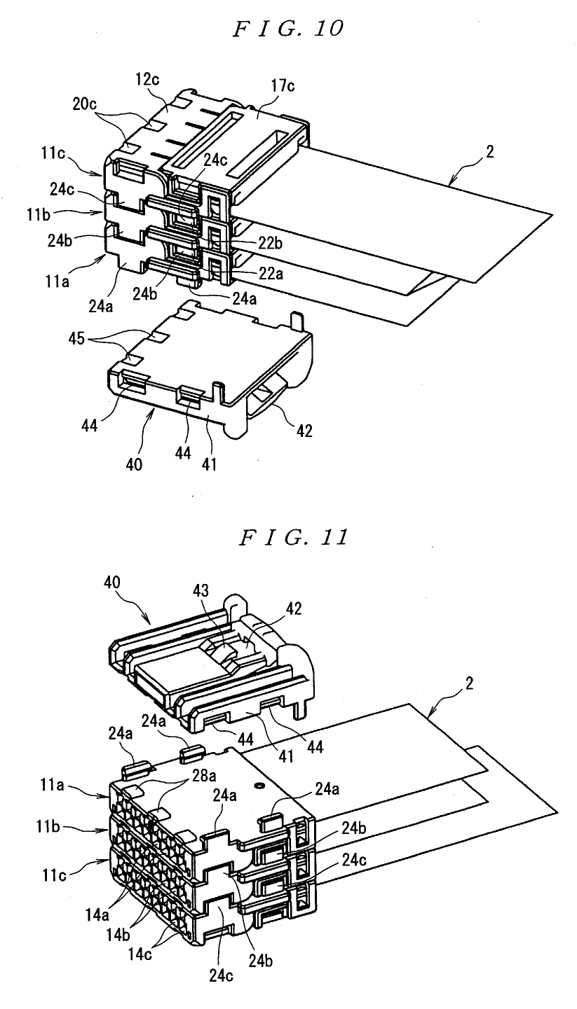

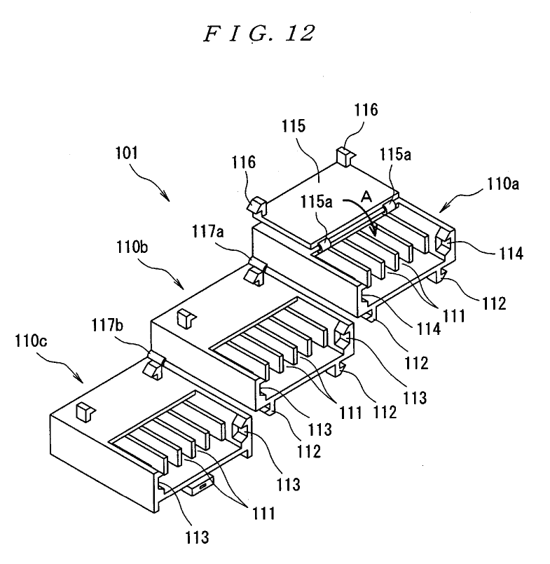

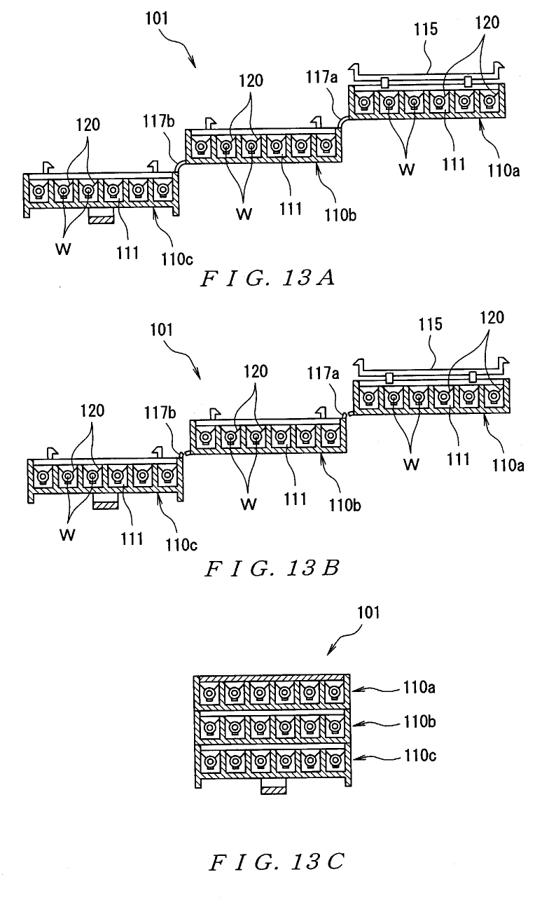

Subsequently, by folding the FPC 2, the middle-stage base housing 11b is stacked on top of the lower-stage base housing 11c, and the upper-stage base housing 11a is stacked on top of the middle-stage base housing 11b as shown in FIGS. 10 and 11. In this case, the locking projections 24c, 24c of the lower-stage base housing 11c engage with the locking recesses 21b, 22b of the middle-stage base housing 11b, so that the lower-stage base housing 11c and middle-stage base housing 11b are locked together. Furthermore, the locking projections 24b, 24b of the middle-stage base housing 11b engage with the locking recesses 21a, 22a of the upper-stage base housing 11a, so that the middle-stage base housing 11b and upper-stage base housing 11a are locked together. The protruding parts of the lower-stage base housing 11c are fitted into the grooves 20b in the middle-stage base housing 11b, thus preventing excessive looseness between the lower-stage base housing 11c and middle-stage base housing 11b, and the protruding parts of the middle-stage base housing 11b are fitted into the grooves 20a in the upper-stage base housing 11a, thus preventing excessive looseness between the middle-stage base housing 11b and upper-stage base housing 11a.

Finally, the lock housing 40 is attached to the surface of the upper-stage base housing 11a located in the uppermost position of the stacked upper-stage, middle-stage, and lower-stage base housings 11a, 11b, and 11c. In this case, the locking projections 24a, 24a of the upper-stage base housing 11a engage with the locking recesses 44, 44 in the lock housing 40, so that the lock housing 40 is locked with the upper-stage base housing 11a. Furthermore, the protruding parts 28a of the upper-stage base housing 11a are fitted into the grooves 45 in the lock housing 40, thus preventing excessive looseness of the lock housing 40. As a result, arrangement of the wire harness 1 is completed.

In this method for arranging wire harness 1, after the plurality of contacts 30a, 30b, and 30c are connected to the FPC 2, the plurality of contacts 30a, 30b, and 30c are respectively inserted into the contact receiving cavities 16a, 16b, and 16c in a single row in the upper-stage, middle-stage, and lower-stage base housings 11a, 11b, and 11c, and the respective upper-stage, middle-stage, and lower-stage base housings 11a, 11b, and 11c are successively passed through the opening in the transmission case, after which the upper-stage, middle-stage, and lower-stage base housings 11a, 11b, and 11c are stacked, thus accomplishing the arrangement of the wire harness 1. Accordingly, the opening bored in the transmission case can be made small. Furthermore, there is no need to cut thin parts that are provided in order to form a plurality of base housings as one linked body in a single molding process as in the past, so that arranging of wire harness is facilitated and simplified. Moreover, since the upper-stage, middle-stage, and lower-stage base housings 11a, 11b, and 11c are formed to be mutually stackable and have the same shape, the number of parts is small, and when the number of base housings is increased or decreased in cases where the number of poles of the contacts is increased or decreased, it is not necessary to manufacture a new mold, so that it is possible to obtain an electrical connector at a low cost with a high degree of freedom in the housing construction.

In addition, the plurality of contacts 30a, 30b, and 30c connected to the FPC 2 are respectively inserted in the contact receiving cavities 16a, 16b, and 16c in a single row in the upper-stage, middle-stage, and lower-stage base housings 11a, 11b, and 11c, so that the contact accommodation work is easier than in the case of inserting a plurality of contacts connected to an FPC in the contact receiving cavities that are formed in multiple rows to begin with, and the contact accommodation work by means of an automated device or the like also becomes possible.

An embodiment of the present invention has been described above. However, the present invention is not limited to this embodiment, and various alterations and modifications can be made.

For example, it is sufficient if the electrical connector 10 is a connector that is connected to a flat cable such as a flexible flat cable (FFC) other than an FPC.

Furthermore, not only to one end of an FPC 2 (flat cable), but the electrical connector 10 may also be connected to both one end and the other end, or only to the other end, or may also be connected to a connecting part that is branched out from an intermediate portion of the FPC 2.

Moreover, as long as the electrical connector 10 comprises a plurality of mutually stackable base housings, this electrical connector is not limited to a connector comprising upper-stage, middle-stage, and lower-stage base housings 11a, 11b, and 11c.

In addition, in the embodiment described above, a lock housing 40 is attached only to the upper surface of the upper-stage base housing 11a. However, it would also be possible to attach two lock housings 40 to both the upper-stage and lower-stage base housings 11a and 11c, or to attach a lock housing 40 only to the undersurface of the lower-stage base housing 11c. In other words, it is sufficient if at least one lock housing is attached to the uppermost and/or lowermost base housing of the plurality of stacked base housings.

Furthermore, the use of the wire harness 1 is not limited to a case in which this wire harness 1 is used for the connection to a controller for an automotive transmission; this wire harness may also be used in another electrical circuitry. Moreover, when arranging wire harness 1, the respective upper-stage, middle-stage, and lower-stage base housings 11a, 11b, and 11c may also be passed successively through an opening bored in a housing other than a transmission case.

1. An electrical connector connected to a flat cable, comprising:
a plurality of mutually stackable base housings having the same shape, with each of these base housings having contact receiving cavities in a single row;
at least one lock housing that is attached to the uppermost and/or lowermost base housing of the plurality of stacked base housings; and
a plurality of contacts that are connected to the flat cable and that are inserted into the contact receiving cavities in the plurality of base housings.

2. The electrical connector according to claim 1, wherein a strain relief member that relieves the stress generated in the flat cable when an external force is applied to the flat cable is provided in an integral manner on each of the plurality of base housings via a hinge part.

3. A wire harness in which an electrical connector is connected to a flat cable, wherein the electrical connector comprises: a plurality of mutually stackable base housings having the same shape, with each of the base housings having contact receiving cavities in a single row; at least one lock housing that is attached to the uppermost and/or lowermost base housing of the plurality of stacked base housings; and a plurality of contacts that are connected to the flat cable and that are inserted into the contact receiving cavities in the plurality of base housings.

4. The wire harness according to claim 3, wherein a strain relief member that relieves the stress generated in the flat cable when an external force is applied to the flat cable is provided in an integral manner on each of the plurality of base housings via a hinge part.

5. A method for arranging wire harness comprising the steps of:
connecting a plurality of contacts to a flat cable;
inserting the plurality of contacts in the contact receiving cavities in a single row in a plurality of base housings;
passing each of the plurality of base housings successively through an opening in a housing;
stacking the plurality of base housings; and
attaching at least one lock housing to the uppermost and/or lowermost base housing of the plurality of stacked base housings.

6. The method for arranging wire harness according to claim 5, wherein following the insertion of the plurality of contacts in the contact receiving cavities in the plurality of base housings, a strain relief member that is provided in an integral manner on each of the plurality of base housings via a hinge part and that relieves the stress generated in the flat cable is pivoted about the hinge part.
